(19) United States
(12) Patent Application Publication
(10) Pub. No.: US 2025/0272066 A1
(43) Pub. Date: Aug. 28, 2025

(54) Configurable Sample Code Generator For Computing Environments

(71) Applicant: Oracle International Corporation, Redwood Shores, CA (US)

(72) Inventor: Marc Gueury, Gembloux (BE)

(73) Assignee: Oracle International Corporation, Redwood Shores, CA (US)

(21) Appl. No.: 18/597,334

(22) Filed: Mar. 6, 2024

Related U.S. Application Data
(60) Provisional application No. 63/558,278, filed on Feb. 27, 2024.

(51) Int. Cl. G06F 8/34; G06F 8/36; G06F 8/61

(52) U.S. Cl. CPC G06F 8/34; G06F 8/36; G06F 8/64

(57) ABSTRACT

Techniques for generating sample code for a configured computing environment are disclosed. A system receives a plurality of user-selected component types for a computing environment. The system selects a first set of code for a first user-selected component type and a second set of code for a second user-selected component type. A selected set of code for a user-selected component type may include a first subset of code that is statically associated with the user-selected component type and a second subset of code that is selected based on a compatibility between the user-selected component type and another user-selected component type. The system generates sample code that is executable in a computing environment corresponding to the first and second user-selected component types from the first and second sets of code.

### INCORPORATION BY REFERENCE; DISCLAIMER

Each of the following applications are hereby incorporated by reference: Application No. 63/558,278, filed Feb. 27, 2024. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to a configurable sample code generator that creates executable sample code for a computing environment. In particular, the present disclosure relates to a configurable sample code generator that creates executable sample code for a computing environment configured according to user selections of computing component types.

### BACKGROUND

A software developer is typically able to write software in one to a few different programming languages and may be able to write software for a specific configuration of a cloud computing environment. When the software developer needs to write software in an unfamiliar programming language or for an unfamiliar configuration of a cloud computing environment, they may turn to a sample code generator to create a sample of code that the developer can extend to include the desired functionality. Existing sample code generators typically produce sample code for one specific computing environment configuration. Because there are many different possible configurations for computing environments, a sample code generator may not exist for a particular configuration needed.

The approaches described in this section are approaches that could be pursued, but not necessarily approaches that have been previously conceived or pursued. Therefore, unless otherwise indicated, one should not assume that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates a system in accordance with one or more embodiments;

FIG. 7 illustrates an example set of operations for generating sample code for a computing environment in accordance with one or more embodiments;

FIGS. 8A-C illustrate examples of graphical user interfaces in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. SAMPLE CODE GENERATOR ARCHITECTURE
5. GENERATING SAMPLE CODE FOR A COMPUTING ENVIRONMENT
6. GRAPHICAL USER INTERFACE
7. PRACTICAL APPLICATIONS, ADVANTAGES, AND IMPROVEMENTS
8. MISCELLANEOUS; EXTENSIONS

### 1. General Overview

One or more embodiments implement a target component type using a combination of code that is statically associated with a target component type and code that is selected at runtime based on a compatibility with other component types to be implemented within a same computing environment. A configurable sample code generator allows a user to select a computing environment configuration from a variety of options. The configurable sample code generator may allow a user to select, for example, a type of user interface, a type of database, a programming language, and a deployment type. The sample code generator may then generate sample code that is executable in the computing environment defined by the user's selected configuration. The configurable sample code generator may allow the user to modify the sample code to include the user's desired functionality and produce code that can operate in the selected computing environment.

The system receives a set of user-selected component types for a corresponding set of components for a computing environment. The system selects code for the individual selected component types. The code for a given component type can include a first subset of code that is statically associated with the component type and/or a second subset of code that is selected based on a compatibility between the second subset of code and another component type in the set of selected component types. The system generates sample code that is executable in the computing environment corresponding to the selected component types from the selected code for the selected component types.

One or more embodiments described in this Specification and/or recited in the claims may not be included in this General Overview section.

### 2. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on the VMs, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming the entity's own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment, such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on one another, and how they work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

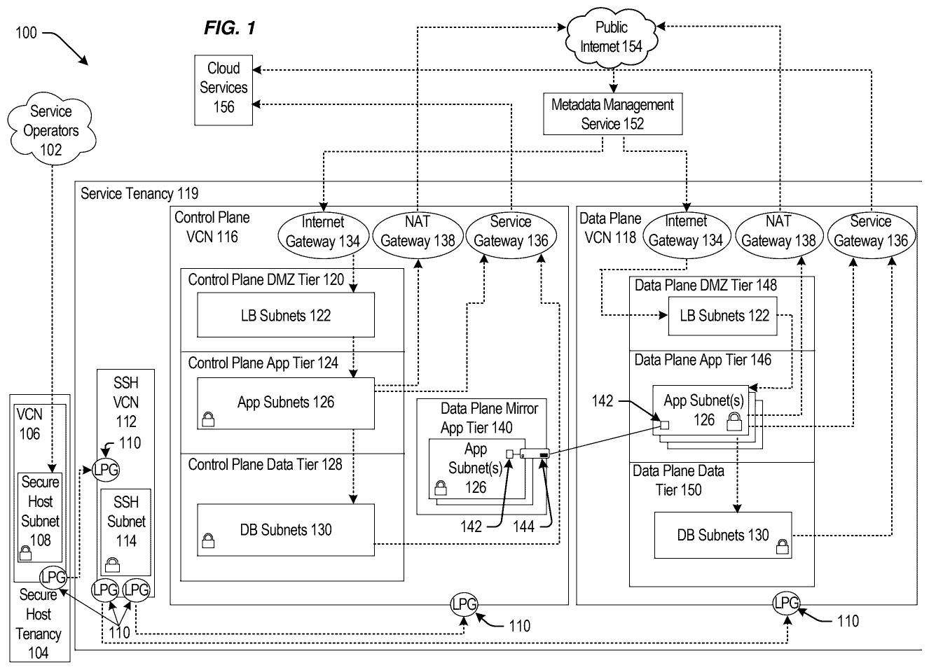

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

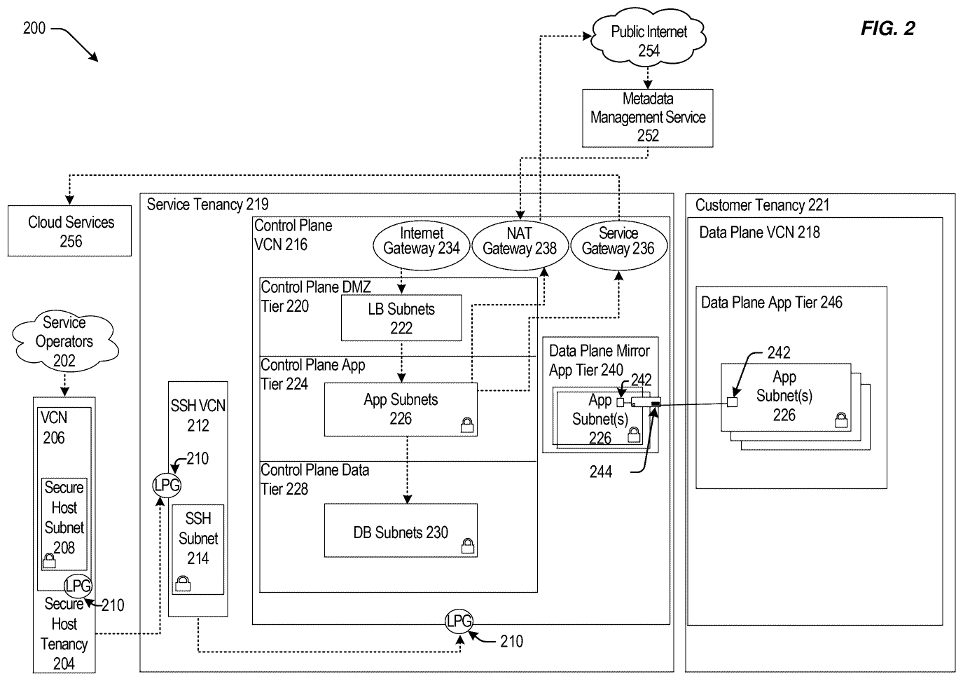

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for a customer, and the IaaS provider may, for a customer, set up a unique, compute instance 244 that is contained in the service tenancy 219. A compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

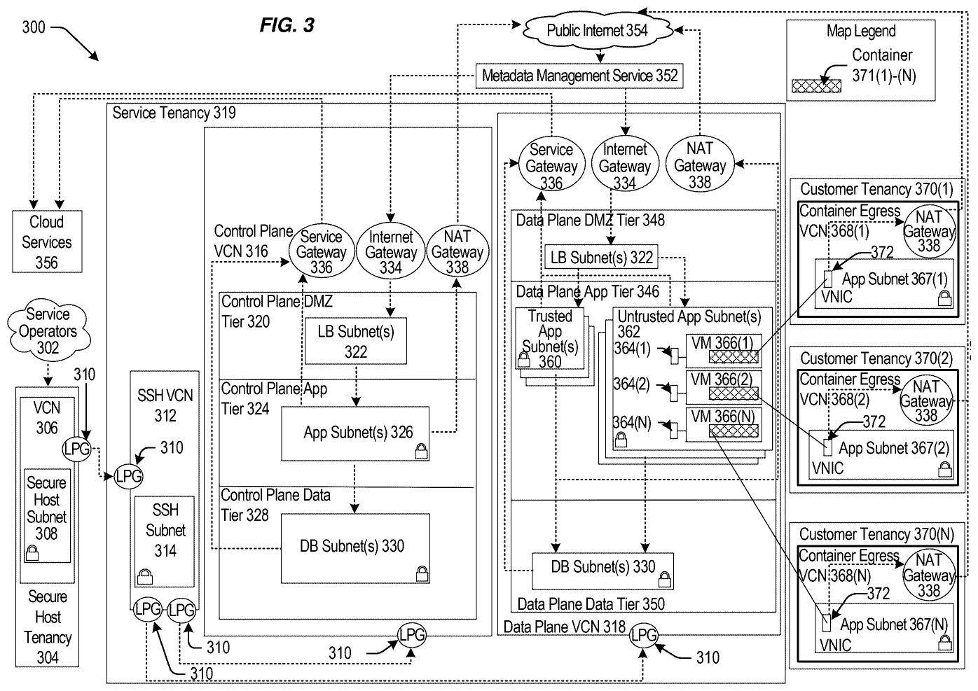

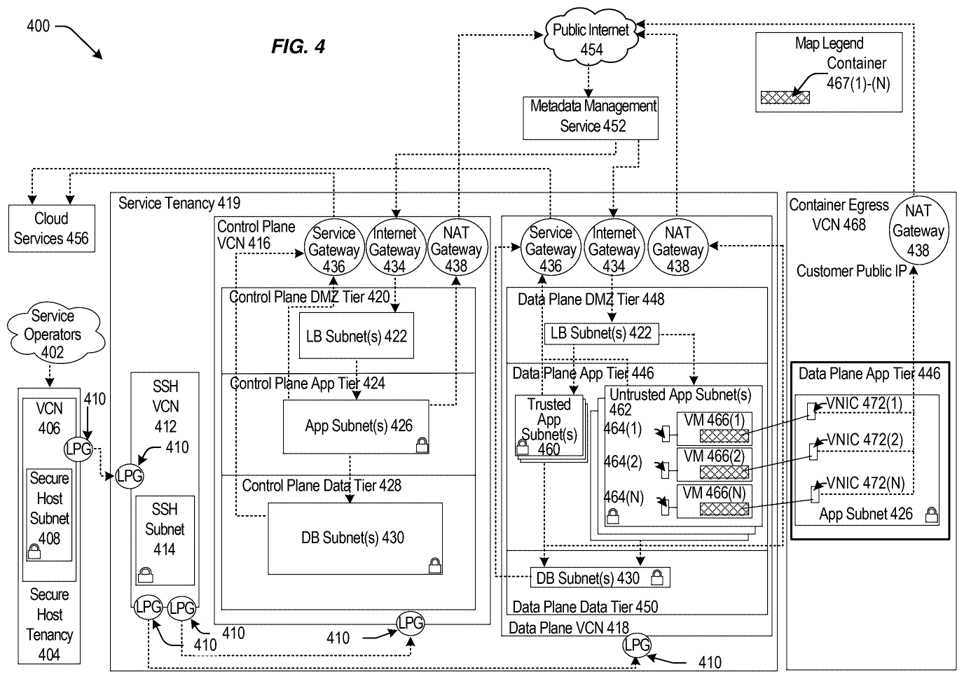

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). The tenants VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). The individual container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. An individual VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of a customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. The individual tenant VMs 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for a customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from one another. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of one another. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from one another (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on one another. A call from an application at the private cloud to an application at the public cloud (and vice versa) may be executed through the interface.

In an embodiment, tenants of a multi-tenant computer network are independent of one another. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with one another. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 3. Computer System

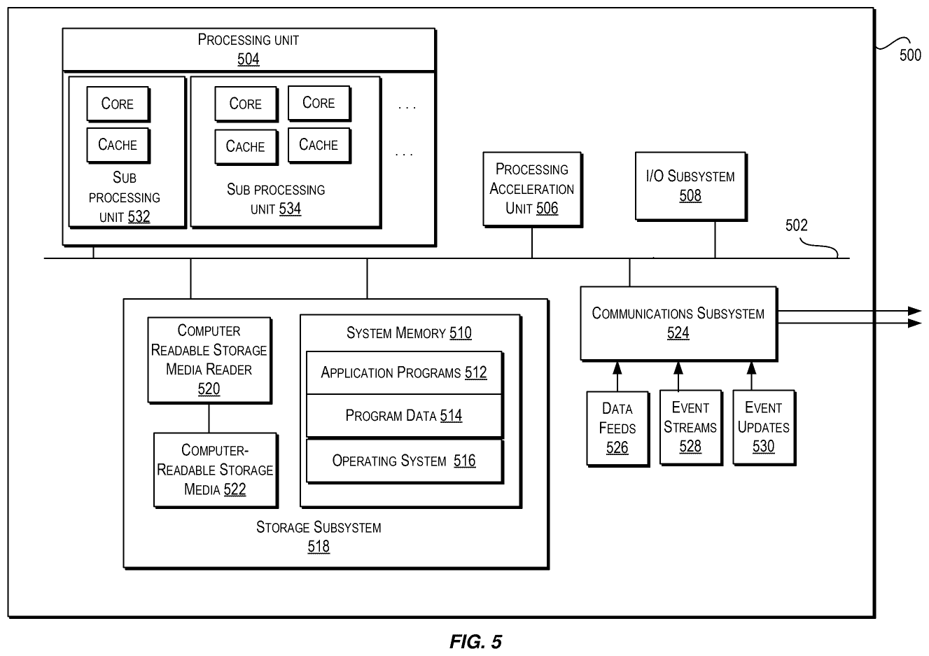

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with one another as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in a processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WIFI (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. Sample Code Generator Architecture

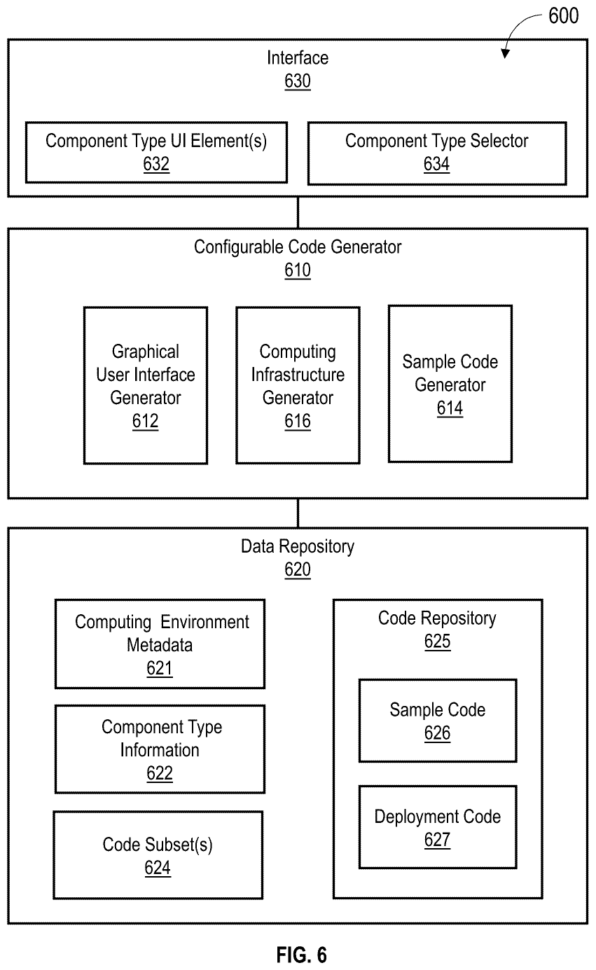

FIG. 6 illustrates a system 600 in accordance with one or more embodiments. As illustrated in FIG. 6, system 600 includes a configurable code generator 610, a data repository 620, and an interface 630. Configurable code generator 610 may include one or more functional components, such as a graphical user interface (GUI) generator 612, a sample code generator 614, and a computing infrastructure generator 616. In one or more embodiments, the system 600 may include more or fewer components than the components illustrated in FIG. 6. The components illustrated in FIG. 6 may be local to or remote from one another. The components illustrated in FIG. 6 may be implemented in software and/or hardware. The components may be distributed over multiple applications and/or machines. Multiple components may be combined into one application and/or machine. Operations described with respect to one component may instead be performed by another component.

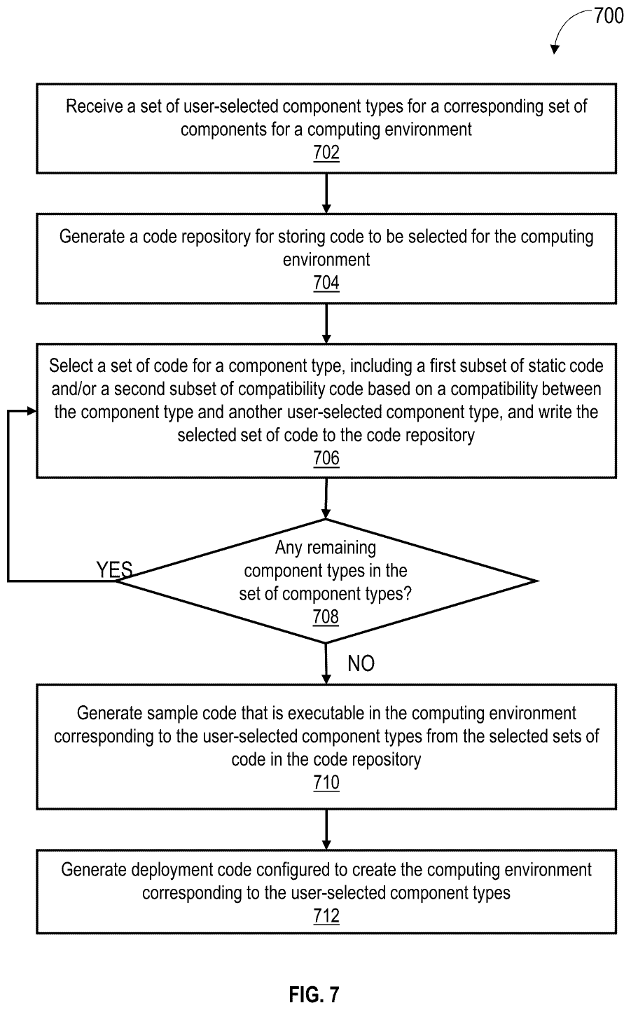

In one or more embodiments, configurable code generator 610 refers to hardware and/or software configured to perform operations described herein for generating sample code for a computing environment. Examples of operations for generating sample code for a computing environment are described below with reference to FIG. 7.

In one or more embodiments, the graphical user interface (GUI) generator 612 refers to hardware and/or software configured to perform operations described herein for displaying one or more component type user interface (UI) elements 632 in a GUI, receiving user inputs via a component type selector 634, and providing information corresponding to the selections to the sample code generator 614 and/or to the computing infrastructure generator 616. For example, GUI generator 612 may present interface elements corresponding to one or more component types. The interface elements may allow the user to indicate, for a given component, the component type to use when generating the sample code and the computing environment for executing the sample code. Other interface elements may allow the user to choose to use an existing component. Still other interface elements may allow the user to choose a downloadable version of the sample code or a cloud computing environment executable version of the sample code. GUI generator 612 may dynamically update a display of component type UI elements 632 based on the specific component types that are selected.

GUI generator 612 may refer to computing environment metadata 621 and component type information 622 to determine the component type UI elements 632 to present. Computing environment metadata 621 may include the categories of components that may be included in a computing environment. The categories of components may include a deployment component, a user interface component, a backend language component, and a database component. Component type information 622 may include information about the specific component types that are available for a category of components. A deployment component may refer to the infrastructure for running the sample code. Deployment component types may include a compute instance, a virtual machine, a Kubernetes cluster, and a container instance. A user interface component may refer to a programming language, a code library, or a system for creating and presenting a user interface. User interface component types may include HTML, ReactJS, Angular, JET Transaction UI from Oracle International Corporation, and PHP from The PHP Group. A backend language component may refer to the programming language that will be used to generate the sample code. Backend language component types may include Java, Node, Python, .Net, Go, and Oracle REST Data Services (ORDS). A database component may refer to a type of database that the sample code may use and/or create. Database component types may include an autonomous database, an Oracle database, a MySQL database, and a pluggable database. GUI generator 612 may render component type UI elements 632 that correspond to the component types.

Component type information 622 may include sub-categories for a component type. For example, the Java backend language may have different frameworks that can be used. A particular framework may be included as a sub-category for the Java component type.

Component type information 622 may include information that indicates system configuration requirements for a component type. For example, to use Java as a backend programing language, Java needs to be installed onto the deployment component.

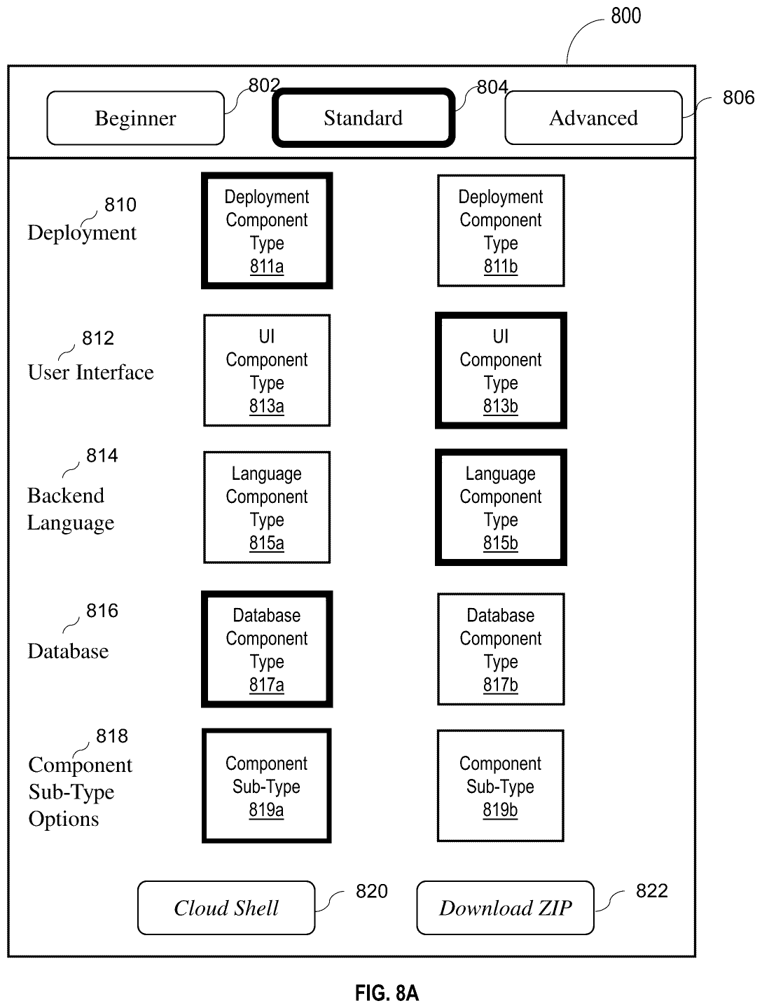

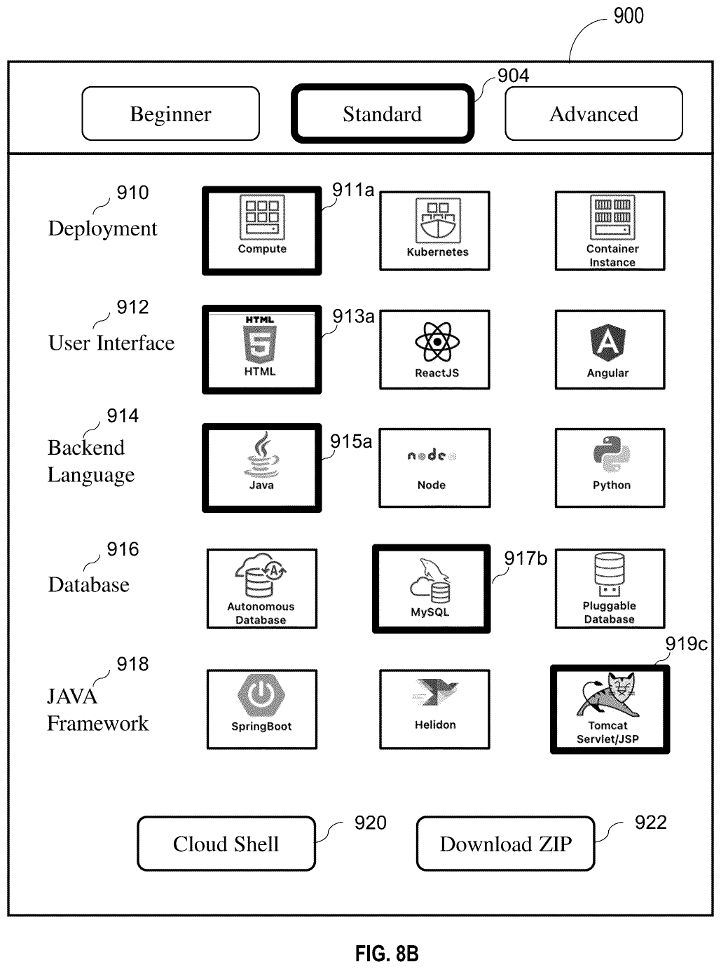

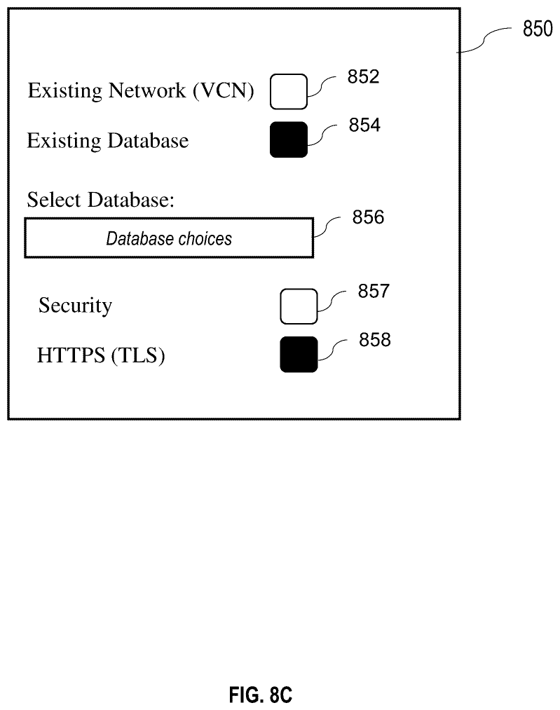

In one or more embodiments, component type selector 634 is configured to present a selectable interface with respect to the component type UI elements. For example, component type selector 634 may make the component type UI elements selectable by “click” from an input device. In another example, component type selector 634 may provide checkboxes, toggle switches, or other selectable elements in association with the component type UI elements. In another example, component type selector 634 may provide a drag-and-drop interface for component type element selection. Component type selector 634 may provide interface elements to confirm a set of selections and interface elements that cause generation of sample code when selected. Examples of GUIs are discussed below in reference to FIGS. 8A-C.

In one or more embodiments, sample code generator 614 refers to hardware and/or software configured to perform operations described herein for generating sample code according to the user-selected component types for a computing environment. Sample code generator 614 may receive a user selection of component types from the component type selector 634 and generate code 626 that is executable on the computing environment defined by the user-selected components. In an embodiment, sample code 626 performs the same functions when executed, regardless of the particular user-selected component types. For example, sample code 626 may create and populate a database with preset data and present the populated database visually via an interface. In an embodiment, sample code 626 is native to a cloud computing environment.

Sample code generator 614 may access one or more code subsets 624 when generating sample code. A code subset 624 may include a subset of static code to perform a function, such as starting up the computing environment, creating a database table, populating a database table, or presenting a database table visually. Static code may include code that does not interact with any other user-selected component types. In one or more embodiments, a subset of static code may be written in one of the backend language component types, and there may be subsets of static code written in the other different backend language component types.

A code subset 624 may include a subset of compatibility code that can be added to the static code to allow one user-selected component type to interact with another user-selected component type. The compatibility code may, for example, enable a deployment component type to compile and execute instructions written in the backend language component type. The compatibility code may enable a deployment component type to generate a user interface according to the user interface component type. In one or more embodiments, sample code generator 614 dynamically combines the static code and the compatibility code corresponding to the user-selected component types to produce the executable sample code.

Sample code generator 614 may create a code repository 625 prior to generating sample code 626. Sample code generator 614 may store sample code 626 in code repository 625. Code repository 625 may include sub-directories corresponding to the different component types.

In one or more embodiments, computing infrastructure generator 616 refers to hardware and/or software configured to perform operations described herein for generating deployment code according to the user-selected component types for a computing environment. Computing infrastructure generator 616 generates deployment code 627. Deployment code 627 may be an instance of infrastructure as code. When executed, deployment code 627 may set up the computing resources to be used to execute the sample code, for example, within a cloud computing environment.

In one or more embodiments, a data repository 620 is any type of storage unit and/or device (e.g., a file system, database, collection of tables, or any other storage mechanism) for storing data. Further, a data repository 620 may include multiple different storage units and/or devices. The multiple different storage units and/or devices may or may not be of the same type or located at the same physical site. Further, a data repository 620 may be implemented or executed on the same computing system as configurable code generator 610. Additionally, or alternatively, a data repository 620 may be implemented or executed on a computing system separate from configurable code generator 610. The data repository 620 may be communicatively coupled to configurable code generator 610 via a direct connection or via a network.

Information describing computing environment metadata 621, component type information 622, code subset(s) 624, and code repository 625 may be implemented across any of components within the system 600. However, this information is illustrated within the data repository 620 for purposes of clarity and explanation.

In one or more embodiments, interface 630 refers to hardware and/or software configured to facilitate communications between a user and sample code generator 610. Interface 630 renders user interface elements, such as component type UI elements 632, and receives input via user interface elements. Examples of interfaces include a graphical user interface (GUI), a command line interface (CLI), a haptic interface, and a voice command interface. Examples of user interface (UI) elements include checkboxes, radio buttons, dropdown lists, list boxes, buttons, toggles, text fields, date and time selectors, command lines, sliders, pages, and forms.

In an embodiment, different components of interface 630 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 630 is specified in one or more other languages, such as Java, C, or C++.

In an embodiment, system 600 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 5. Generating Sample Code for a Computing Environment

FIG. 7 illustrates an example set of operations for or generating sample code for a computing environment in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments.

In an embodiment, the system receives a set of user-selected component types for a corresponding set of components for a computing environment (Operation 702). The system may receive the set via an interface after a user has selected the set of component types and requested, via an interface element, that the sample code be generated. The system may also receive a user selection for how the user wishes to receive the sample code, for example, as a downloadable file or set of files, or within a browser environment.

In an embodiment, the system generates a code repository for storing code to be selected for the computing environment (Operation 704). The system may allocate a portion of a storage device for storing the sample code. Within the allocated storage, the system may create separate sub-directories. The system may create one sub-directory per user-selected component type to contain the code and other resources used by the user-selected component type. In some cases, one sub-directory may be used to contain the code for multiple component types. The sub-directories may share the same directory hierarchical level. Some sub-directories may be nested within another sub-directory. The system may also create a sub-directory for storing deployment code.

In an embodiment, the system selects a set of code for a user-selected component type (Operation 706). The system may select static code for the user-selected component type. The system may select compatibility code for the user-selected component type based on one or more of the other user-selected component types. For example, the system may select compatibility code for a database client corresponding to a user-selected databased component type, so the deployment component type can access the database. In another example, the system may select compatibility code for a user-selected backend language component corresponding to the user-selected deployment component type such that the user-selected deployment component is able to understand, compile, and execute instructions in the backend language. The system adds the selected set of code to the code repository.

In an embodiment, the system determines if there are any remaining component types in the set of user-selected component types (Operation 708). When there are remaining user-selected component types in the set, the system returns to Operation 706 for another user-selected component type from the set.

In an embodiment, when there are no remaining user-selected component types in the set, the system generates sample code from the selected sets of code in the code repository (Operation 710). The system may access the code from the code repository. The system may combine the static code and the compatibility code for the user-selected component types. For example, the system may add compatibility code for a database client to static code for the deployment component. The system may add code for the backend language to code for the deployment component. Alternatively, the system may link compatibility code to static code such that one may access the other, while keeping the compatibility code separate from the static code. The system may also create an order for executing the code, as some component types may need to be created and/or running before other component types can be created or used.

In one or more embodiments, one of the user-selected component types may be an existing component type rather than one that the deployment code will create. In this case, the system may access configuration information for the existing component type and select the compatibility code based on the configuration information of the existing component. For example, if the existing component is a database, the system may determine the type of the existing database and may select compatibility code for the type of database. The system may confirm that the type matches the component type selected by the user. If the types do not match, the system may update the user-selected component type to match the type of the existing component type.

In an embodiment, the system generates deployment code configured to create the computing environment corresponding to the user-selected component types (Operation 712). The system may generate deployment code based on an architecture determined from the set of user-selected component types. The architecture may be the combination of hardware and software resources associated with the set of user-selected component types and may include resources that are not selected by the user. The system may determine the set of specific computing resources to set up from the user-selected component types. The system may generate deployment code that configures the computing resources according to the user-selected component types, for example, by creating an instance of the deployment component, installing software on the deployment component, creating a database, and establishing connections between the computing resources, for example, by linking a virtual machine to a database.

Once the sample code and deployment code are generated, the system delivers the sample and deployment codes to the user. The system may also include a script to build the environment and execute the sample code. When run, the build script executes the deployment code to create the computing environment. The sample program may then be run within the created computing environment. The sample code file(s) may be opened and modified to change the operations of the sample code. For example, a file may be modified so that the sample code accesses an existing database and performs operations on the existing database. The modified files can still function within the computing environment created by the deployment code.

### 6. Graphical User Interface

FIG. 8A illustrates an example of a graphical user interface 800 as may be generated by the graphical user interface generator 612. The graphical user interface 800 may be presented via interface 130. As shown, the graphical user interface 800 is presenting selectable elements that allow the user to choose how many components of a computing environment the user wishes to choose from. The standard element 804 is selected, and the GUI 800 shows five different components that allow the user to customize a computing environment in which the sample code can execute by selecting a particular component type. The beginner element 802, when selected, may show fewer components to customize. The advanced element 806, when selected, may show more components and/or additional settings to customize.

The GUI 800 presents component types for a deployment component 810, a user interface component 812, a backend language component 814, and a database component 816. While two component types are illustrated for the respective components, more component types may be presented. Some components may have more or fewer component types than other components.

For the deployment component, deployment component type UI element 811a is selected, as indicated by a thicker border. Deployment component type UI element 811b is unselected, as indicated by a thinner border. For the user interface component, UI component type UI element 813a is unselected, and UI component type UI element 811b is selected. For the backend language component, language component type UI element 815a is unselected, and language component type UI element 815b is selected. For the database component, database component type UI element 817a is selected, and database component type UI element 817b is unselected.

GUI 800 may present component sub-type options 818 in response to a user selection of a particular component type. For example, based on the user selection of language component type UI element 815a, GUI 800 may present component sub-type UI elements 819a and 819b. If the user were to unselect UI element 815a or select UI element 815b, the component sub-type options 818 and the UI elements 819a and 819b would be removed.

GUI 800 may present selectable elements that allow the user to specify how the user wishes to receive the sample code. A cloud shell selectable element 820, when selected, may open a web browser-based terminal that allows the user to view and modify the sample code. The terminal may be accessible from a cloud computing console. A download ZIP selectable element 822, when selected, may compress the code repository containing the sample code into a ZIP file and save the file to the user's local device or other specified location. The ZIP file may then be decompressed to allow the user to access, view, and modify the sample code in the user's selected environment.

In one or more embodiments, GUI 800 may initially present the component type UI elements in an unselected state. In other embodiments, GUI 800 may preselect some of the component type UI elements according to a default setting. The selectable elements 820 and 822 may be disabled until selections are received for a component type for the respective presented components.

A detailed example is described below for purposes of clarity. Components and/or operations described below should be understood as one specific example that may not be applicable to certain embodiments. Accordingly, components and/or operations described below should not be construed as limiting the scope of any of the claims.

FIG. 8B illustrates an example of a graphical user interface 900 as may be generated by the graphical user interface generator 612. GUI 900 may be a specific instance of GUI 800. In the illustrated example, the standard element 904 is selected. GUI 900 shows the component types of compute, Kubernetes, and container instance for deployment component 910. The component type UI element 911a corresponding to the compute component type is selected. GUI 900 shows the component types of HTML, ReactJS, and Angular for user interface component 912. The component type UI element 913a corresponding to the HTML component type is selected. GUI 900 shows the component types of Java, Node, and Python for backend language component 914. The component type UI element 915a corresponding to the Java component type is selected. Responsive to the selection of the UI element 915a for Java, GUI 900 shows the component sub-types for a Java framework component, namely, SpringtBoot, Helidon, and Tomcat Servlet/JSP. The component type UI element 919c corresponding to the Tomcat Servlet/JSP component type is selected. GUI 900 shows the component types of autonomous database, Oracle database, and pluggable database for database component 916. The component type UI element 917b corresponding to the MySQL database component type is selected. The selectable elements 920 and 922 may be enabled for selection once the component types for components in the presented set of components are selected.

FIG. 8C illustrates an example of a graphical user interface 850 as may be generated by the graphical user interface generator 612. GUI 850 may be present within GUI 800 when the advanced element 806 is selected. GUI 850 presents options that allows the user to choose to use existing computing environment resources, such as an existing network and/or an existing database.

GUI 850 is presenting a selectable element 852 corresponding to an option to use an existing network such as a virtual cloud network. As illustrated, the selectable element 852 is unselected. GUI 850 is presenting a selectable element 854 corresponding to an option to use an existing database. The selectable element 854 is selected. In one or more embodiments, responsive to a selection of a selectable element, GUI 850 may present an entry field 856 that allows the user to indicate the particular existing computing environment resource to use. Entry field 856 may be a text entry field, that allows the user to type or paste a text string that identifies the name and location of the existing resource. Entry field 856 may provide a navigation interface that allows the user to navigate through a file directory system to select the existing resource. In other embodiments, GUI 850 may not present an entry field. Instead, when the sample code is generated, a placeholder for the existing resource may be inserted into the sample code for the user to replace with the information needed for the sample code to access and use the existing resource.

GUI 850 also presents a selectable element 857 that allows the user to enable a security feature that may include a login feature for the generated sample code. GUI 850 presents a selectable element 858 that allows the user to enable the use of the HTTPS protocol in place of HTTP within the sample code and/or within the computing environment generated according to the user-selected component types.

### 7. Practical Applications, Advantages, and Improvements

Existing sample code generators are typically able to produce sample code for a single computing environment configuration. If a user needs to create software that operates in a computing environment configuration that is unfamiliar to the user, and if there is no sample code generator available for that computing environment configuration, then the user may need to spend time and other resources to learn how to create the software for the configuration on their own.

One or more embodiments of the configurable code generator allow the user to create executable sample code for any of a number of combinations of computing environment configurations using industry best practices for configuring the computing environment component types together. This allows a user to create software for many different computing environments without having to develop expertise in the many different computing environments.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and reasonable effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form that claims issue, including any subsequent correction.

What is claimed is:

1. One or more non-transitory computer readable media comprising instructions that, when executed by one or more hardware processors, cause performance of operations comprising:
receiving, by a computing device, a plurality of user-selected component types for a corresponding plurality of components for a computing environment, the plurality of user-selected component types comprising:
a first user-selected component type for a first component of the plurality of components; and
a second user-selected component type for a second component of the plurality of components;
selecting, by the computing device, a first set of code for the first component, the first set of code comprising:
a first subset of code that is statically associated with the first user-selected component type; and
a second subset of code that is selected based on a compatibility between the first user-selected component type and the second user-selected component type;
selecting, by the computing device, a second set of code for the second component; and
generating sample code that is executable in the computing environment corresponding to the first and second user-selected component types at least by incorporating the first subset of static code, the second subset of code, and the second set of code into the sample code.

2. The one or more non-transitory computer readable media of claim 1, the operations further comprising selecting a subset of code from a plurality of subsets of code as the second subset of code based on the second subset of code enabling communication with the second component.

3. The one or more non-transitory computer readable media of claim 1, the operations further comprising: based on the plurality of user-selected component types for the plurality of components, generating, by the computing device, deployment code for deploying the computing environment, with the plurality of components of the user-selected component types, on a set of hardware resources.

4. The one or more non-transitory computer readable media of claim 3, the operations further comprising generating a code repository and storing the first set of code, the second set of code, and the deployment code therein.

5. The one or more non-transitory computer readable media of claim 3, the operations further comprising:
determining a system architecture for the computing environment based on the first user-selected component type and the second user-selected component type; and
generating the deployment code based on the system architecture.

6. The one or more non-transitory computer readable media of claim 5, wherein the system architecture comprises supporting components that are (a) not user-selected components and (b) required for implementation of the plurality of components of the plurality of user-selected component types.

7. The one or more non-transitory computer readable media of claim 3, the operations further comprising:
determining an ordered sequence of operations for deploying the computing environment based on the first user-selected component type and the second user-selected component type; and
generating the deployment code based on the ordered sequence of operations.

8. The one or more non-transitory computer readable media of claim 1, wherein the second user-selected component type corresponds to an existing component, and the operations further comprising:
accessing configuration information for the existing component; and
selecting the second subset of code based on the configuration information of the existing component.

9. The one or more non-transitory computer readable media of claim 8, the operations further comprising:
presenting a candidate set of existing components, responsive to receiving the second user-selected component type, by analyzing the computing environment; and
receiving a selection of the existing component from the candidate set.

10. The one or more non-transitory computer readable media of claim 1, wherein generating the sample code includes:
incorporating, into the sample code, the first set of code for the first user-selected component type and a second set of code for the second user-selected component type; and
configuring the first set of code and the second set of code to enable communication between components corresponding to the first user-selected component type and the second user-selected component type.

11. The one or more non-transitory computer readable media of claim 1, the operations further comprising:
generating a graphical user interface (GUI) configured to present selectable component types for a plurality of component types and to receive a selection of a component type for a presented component type.

12. The one or more non-transitory computer readable media of claim 11, wherein the GUI is further configured to dynamically update the selectable component types based on a previous user selection.

13. The one or more non-transitory computer readable media of claim 1, wherein the computing environment is a cloud computing environment.

14. A method comprising:
receiving, by a computing device, a plurality of user-selected component types for a corresponding plurality of components for a computing environment, the plurality of user-selected component types comprising:
a first user-selected component type for a first component of the plurality of components; and
a second user-selected component type for a second component of the plurality of components;
selecting, by the computing device, a first set of code for the first component, the first set of code comprising:
a first subset of code that is statically associated with the first user-selected component type; and
a second subset of code that is selected based on a compatibility between the first user-selected component type and the second user-selected component type;
selecting, by the computing device, a second set of code for the second component; and
generating sample code that is executable in the computing environment corresponding to the first and second user-selected component types at least by incorporating the first subset of static code, the second subset of code, and the second set of code into the sample code;
wherein the method is performed by at least one device including a hardware processor.

15. The method of claim 14, further comprising selecting a subset of code from a plurality of subsets of code as the second subset of code based on the second subset of code enabling communication with the second component.

16. The method of claim 14, further comprising, further comprising: based on the plurality of user-selected component types for the plurality of components, generating, by the computing device, deployment code for deploying the computing environment, with the plurality of components of the user-selected component types, on a set of hardware resources.

17. The method of claim 16, further comprising generating a code repository and storing the first set of code, the second set of code, and the deployment code therein.

18. The method of claim 16, further comprising:
determining an ordered sequence of operations for deploying the computing environment based on the first user-selected component type and the second user-selected component type; and
generating the deployment code based on the ordered sequence of operations.

19. The method of claim 14, wherein the second user-selected component type corresponds to an existing component, and the method further comprising:
accessing configuration information for the existing component; and
selecting the second subset of code based on the configuration information of the existing component.

20. The method of claim 14, wherein generating the sample code includes:
incorporating, into the sample code, the first set of code for the first user-selected component type and a second set of code for the second user-selected component type; and
configuring the first set of code and the second set of code to enable communication between components corresponding to the first user-selected component type and the second user-selected component type.

21. The method of claim 14, further comprising:
generating a graphical user interface (GUI) configured to present selectable component types for a plurality of component types and to receive a selection of a component type for a presented component type.

22. A system comprising:
at least one device including a hardware processor;
the system being configured to perform operations comprising:
receiving, by a computing device, a plurality of user-selected component types for a corresponding plurality of components for a computing environment, the plurality of user-selected component types comprising:
a first user-selected component type for a first component of the plurality of components; and
a second user-selected component type for a second component of the plurality of components;
selecting, by the computing device, a first set of code for the first component, the first set of code comprising:
a first subset of code that is statically associated with the first user-selected component type; and
a second subset of code that is selected based on a compatibility between the first user-selected component type and the second user-selected component type;
selecting, by the computing device, a second set of code for the second component; and
generating sample code that is executable in the computing environment corresponding to the first and second component types at least by incorporating the first subset of static code, the second subset of code, and the second set of code into the sample code.

23. The system of claim 22, the operations further comprising selecting a subset of code from a plurality of subsets of code as the second subset of code based on the second subset of code enabling communication with the second component.

24. The system of claim 22, the operations further comprising: based on the plurality of user-selected component types for the plurality of components, generating, by the computing device, deployment code for deploying the computing environment, with the plurality of components of the user-selected component types, on a set of hardware resources.

25. The system of claim 24, the operations further comprising generating a code repository and storing the first set of code, the second set of code, and the deployment code therein.

26. The system of claim 24, the operations further comprising:
determining an ordered sequence of operations for deploying the computing environment based on the first user-selected component type and the second user-selected component type; and
generating the deployment code based on the ordered sequence of operations.

27. The system of claim 22, wherein the second component type corresponds to an existing component, and the operations further comprising:
accessing configuration information for the existing component; and
selecting the second subset of code based on the configuration information of the existing component.

28. The system of claim 22, wherein generating the sample code includes:
incorporating, into the sample code, the first set of code for the first user-selected component type and a second set of code for the second user-selected component type; and
configuring the first set of code and the second set of code to enable communication between components corresponding to the first user-selected component type and the second user-selected component type.

29. The system of claim 22, the operations further comprising:
generating a graphical user interface (GUI) configured to present selectable component types for a plurality of component types and to receive a selection of a component type for a presented component type.
